(19) United States
(12) Patent Application Publication
(10) Pub. No.: US 2012/0197671 A1
(43) Pub. Date: Aug. 2, 2012

(54) METHOD AND SYSTEM FOR RESERVING PARTIAL SEATS

(76) Inventors: Richard Postrel, Miami Beach, FL (US); Michael Batt, Ft. Lauderdale, FL (US)

(21) Appl. No.: 13/019,348

(22) Filed: Feb. 2, 2011

(51) Int. Cl. G06Q 10/00

(52) U.S. Cl. 705/5

(57) ABSTRACT

A seat reservation system and method in which a first user requests a reservation computer to reserve a first regular seat and a first partial seat for an event. A second user requests the reservation computer to reserve a second regular seat and a second partial seat for the event. The reservation computer then matches the first partial seat reservation request with the second partial seat reservation request to generate a middle seat reservation request for the event. The reservation computer assigns a first seat, a middle seat, and a second seat consecutively in a single row to the first user and the second user in fulfillment of the first user reservation request for the first regular seat and the first partial seat and the second user reservation request for the second regular seat and the second partial seat.

### TECHNICAL FIELD

This invention relates to a method and system for providing users with the ability to make a reservation for and obtain partial seating in a public environment such as airplanes, trains, theaters, etc.

### BACKGROUND OF THE INVENTION

Many situations exist in which a person is required to reserve a seat ahead of time in a public environment such as an airplane. It is customary for that person to reserve a designated seat in a designated row. Often, the person may wish to obtain a seat in which there is no one next to him, but cannot do so unless he pays for two seats at the time of reservation, which is cost prohibitive. Thus, he is forced to wait until he arrives at the event (i.e. boards the plane) before learning if he has an empty seat next to him.

In addition, some airlines are instituting a policy in which passengers in excess of a stated weight must purchase an extra seat in order to accommodate them without crowding a neighboring passenger, as well as generate additional revenue to help pay for the extra cost in transporting the excess weight.

It is therefore desired to implement a system and methodology in which a person can obtain a seat having an empty seat next to him, without being required to pay for two seats. It is also desired to be able to generate additional revenue for carrying overweight passengers without requiring them to purchase a full additional seat.

### SUMMARY OF THE INVENTION

Thus, provided is a seat reservation system and method in which a first user requests a reservation computer to reserve a first regular seat and a first partial seat for an event. A second user requests the reservation computer to reserve a second regular seat and a second partial seat for the event. The reservation computer then matches the first partial seat reservation request with the second partial seat reservation request to generate a middle seat reservation request for the event. The reservation computer assigns a first seat, a middle seat, and a second seat consecutively in a single row to the first user and the second user in fulfillment of the first user reservation request for the first regular seat and the first partial seat and the second user reservation request for the second regular seat and the second partial seat.

The reservation computer sends to the first user a seat reservation confirmation indicating that the first seat is reserved for the first user and that a half of the middle seat adjoining the first seat is reserved for the first user. The reservation computer also sends to the second user a seat reservation confirmation indicating that the second seat is reserved for the second user and that a half of the middle seat adjoining the second seat is reserved for the second user.

### BRIEF DESCRIPTION OF THE DRAWING

FIG. 1 is a flowchart of the operation of the preferred embodiment of the present invention.

FIG. 2 illustrates the operation of the preferred embodiment of the present invention.

### DETAILED DESCRIPTION OF THE PREFERRED EMBODIMENTS

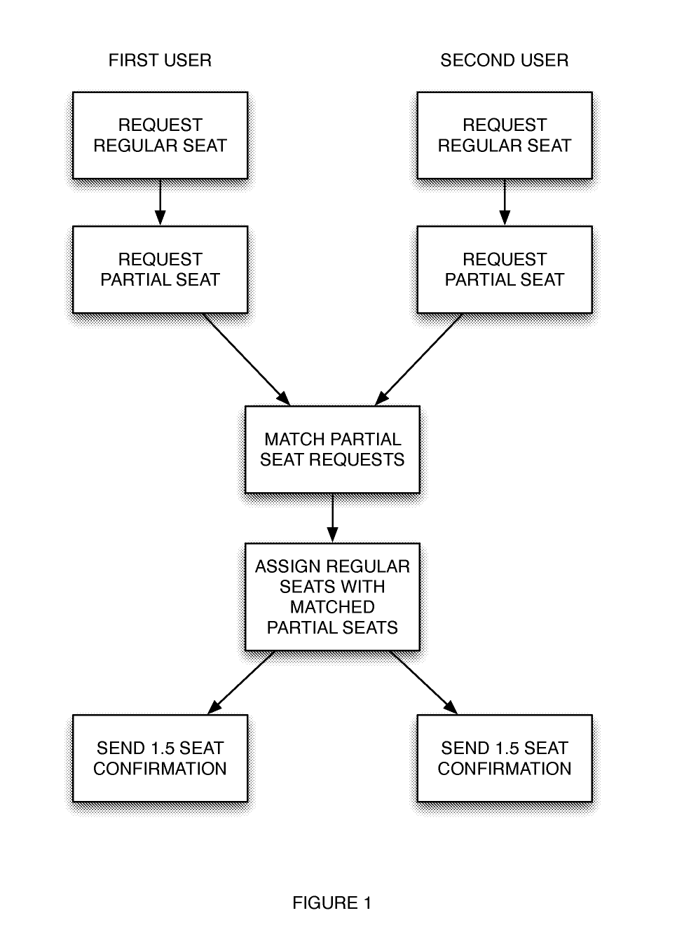

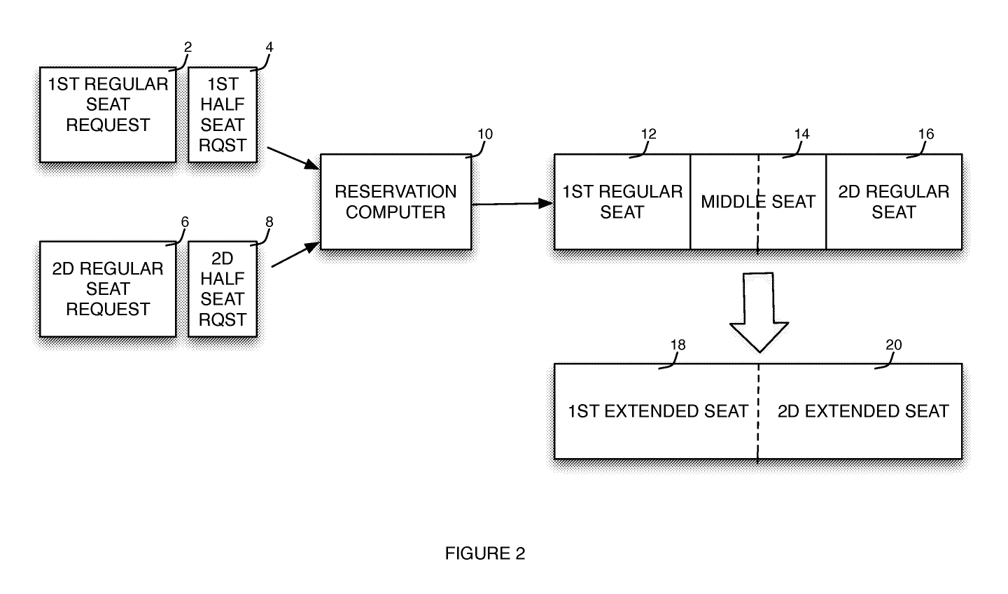

With reference to FIG. 1, in order for a user to obtain a reservation for an extended seat, which in the preferred embodiment is the same as a regular seat and a partial seat (half of the seat next to the regular seat), he will first make a reservation request to a reservation computer 10 as shown in FIG. 2. This may be done using computing devices well known in the art, such as laptop or notebook computers, desktop computers, and/or mobile devices such as smartphones and tablets. These user devices would interconnect with a reservation computer 10 in a manner well known in the art, such as by a network such as the Internet and/or a proprietary network used with travel reservation or ticketing systems. For example, a travel website could offer this invention as part of its reservation process. In addition, a user may interact with the reservation computer 10 via a kiosk, for example at an airport or theater, within the scope of this invention. Likewise, the user may make the reservation request via a telephone, in which an operator with whom the user speaks will make appropriate data entries in order to carry out this invention.

The reservation request made by the user will include the typical information such as event name, date, time, and optionally type of seat or a specific seat. In the case of a flight for example, the user would likely request a certain seat for the flight desired. The user would also make a general request for a partial seat for the same event, which would be required to be made next to the regular seat so the user can take advantage of the wider accommodations. As additional users make similar requests for the same event, the reservation computer 10 can match them in order to fulfill the extended seat requests.

Thus, a first user requests the reservation computer 10 to reserve a first regular seat 2 for an event, and also requests the reservation computer 10 to reserve a first partial seat 4 for the same event. This may be done at the same time as the regular seat request 2 or a later time with reference to the regular seat request 2. A second user will at some time also request the reservation computer 10 to reserve a second regular seat 6 for the event, and also requests the reservation computer 10 to reserve a second partial seat 8 for the same event. Again, this may be done at the same time as the regular seat request 6 or a later time with reference to the regular seat request 6.

Once there have been at least two partial seat requests for the same event, then the reservation computer 10 will match the first partial seat reservation request 4 with the second partial seat reservation request 8 to generate a middle seat 14 reservation request for that event. The reservation computer 10 then assigns the first seat 12, the middle seat 14, and the second seat 16 consecutively in a single row to the first user and the second user in fulfillment of the first user reservation request for the first regular seat and the first partial seat and the second user reservation request for the second regular seat and the second partial seat.

The reservation computer 10 then sends to the first user a seat reservation confirmation indicating that the first seat is reserved for the first user and that a half of the middle seat adjoining the first seat is reserved for the first user. The reservation computer 10 also sends to the second user a seat reservation confirmation indicating that the second seat is reserved for the second user and that a half of the middle seat adjoining the second seat is reserved for the second user. Each user will then pay for one and one half seats for the event since they will be reserved to share the middle seat that is in between them. The first user now will enjoy the comforts of a first extended seat 18 and the second user will enjoy the comforts of a second extended seat 20, as shown in FIG. 2.

Matching of partial seat requests may require the reservation computer 10 to move existing seat reservations around so that requested partial seats will align with each other. Users will be given the option of whether they would allow the reservation computer 10 to move their seats on order to fulfill their partial seat request, or if they do not want their seats moved at all.

The matching algorithm may be implemented by first checking the seat reservations to ascertain if two people have partial seat requests. If so, then those people would be given a set of three seats to use between the two of them. If more than one person has made partial seat requests, then the algorithm may first adhere to specific seat requests, such as someone who requests a window or aisle seat. For example, a user who asks for a window seat and an adjoining partial seat would be matched with a user who requests an aisle seat and an adjoining partial seat.

As described above, there are two possible manners of accomplishing the request for the adjoining partial seat. In one case, the user purchases a regular seat, and then returns to the reservation system to request an adjoining partial seat at a later time. In another case, the purchase of the regular seat and partial seat occur simultaneously.

This invention may also be extended to multiples of the three seat embodiment described herein. For example, if there is a group of four seats, then the four seats may be divided between three passengers so that each passenger pays for one and one third seats.

In another embodiment of the invention, users may be able to bid in an auction for the partial seats when there is a limited number of partial seats available.

Numerous benefits are derived from this invention. From the perspective of the user, he or she is able to obtain additional seating room at a fraction of the cost of purchasing an extra full seat. Since two people can share the extra seat, more people can obtain the extra room of the partial seat than if only full seats were made available to them. The party selling the seat (the airline, theater, stadium, etc.) can gain additional incremental revenue that may not have been generated if only full seats were made available. Also, in the case of an airline, the airline will not have to pay additional taxes and landing fees that would have otherwise have been due if the extra seat were sold in its entirety.

The extra partial seat may be used as a prize in a promotional contest or he like. Alternatively, the extra partial seat may be considered an upgrade, paid for with points, etc.

In a further embodiment, an airline may choose to offer partial seats on flights that have a certain number of seats open as the date and time of the flight approaches. An algorithm may be configured to send communications (such as emails, text messages etc.) to existing passengers that a partial seat is available next to them at a reduced price. This can be done in order to match existing partial seat reservations, or it can be done in cases where full (middle) seats are available so that occupant(s) on either or both sides are offered half of the middle seat. Offers may be made by the airline to rearrange a passenger's requested seat in order to also offer a partial seat next to them where available.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A seat reservation method comprising:
a first user requesting a reservation computer to reserve a first regular seat and a first partial seat for an event;
a second user requesting the reservation computer to reserve a second regular seat and a second partial seat for the event;
the reservation computer matching the first partial seat reservation request with the second partial seat reservation request to generate a middle seat reservation request for the event; and
the reservation computer assigning a first seat, a middle seat, and a second seat consecutively in a single row to the first user and the second user in fulfillment of the first user reservation request for the first regular seat and the first partial seat and the second user reservation request for the second regular seat and the second partial seat.

2. The method of claim 1 further comprising:
the reservation computer sending to the first user a seat reservation confirmation indicating that the first seat is reserved for the first user and that a half of the middle seat adjoining the first seat is reserved for the first user; and
the reservation computer sending to the second user a seat reservation confirmation indicating that the second seat is reserved for the second user and that a half of the middle seat adjoining the second seat is reserved for the second user.

3. A seat reservation computer programmed to:
receive a request from a first user to reserve a first regular seat and a first partial seat for an event;
receive a request from a second user to reserve a second regular seat and a second partial seat for the event;
match the first partial seat reservation request with the second partial seat reservation request to generate a middle seat reservation request for the event; and
assign a first seat, a middle seat, and a second seat consecutively in a single row to the first user and the second user in fulfillment of the first user reservation request for the first regular seat and the first partial seat and the second user reservation request for the second regular seat and the second partial seat.

4. The computer of claim 3 further programmed to
send to the first user a seat reservation confirmation indicating that the first seat is reserved for the first user and that a half of the middle seat adjoining the first seat is reserved for the first user; and
send to the second user a seat reservation confirmation indicating that the second seat is reserved for the second user and that a half of the middle seat adjoining the second seat is reserved for the second user.
